(19) United States
(12) Patent Application Publication
(10) Pub. No.: US 2025/0277537 A1
(43) Pub. Date: Sep. 4, 2025

(54) SOLENOID PLUNGER ALIGNMENT

(71) Applicant: ASCO, L.P., Florham Park, NJ (US)

(72) Inventors: Alexander R. Determan, Grand Blanc, MI (US); Matthew Tyler Hoskins, Oak Park, MI (US)

(21) Appl. No.: 18/590,946

(22) Filed: Feb. 29, 2024

(51) Int. Cl. F16K 27/04; F16K 31/06

(52) U.S. Cl. CPC F16K 27/048; F16K 31/0675; F16K 31/0613

(57) ABSTRACT

A valve can include a valve body having a port section and a coil support section extending along a longitudinal axis, a plunger within a bore of the valve body and extending at least partially through the coil support section, and one or more cylindrical bore bearing surfaces in the bore to align the plunger within the bore.

### CROSS-REFERENCE TO RELATED APPLICATIONS

This application is related to the commonly owned applications entitled “SOLENOID VALVE WITH BARBED SEALING ASSEMBLY,” “VALVE WITH IMPROVED MAGNETIC FLUX INTERFACE,” “SOLENOID VALVE POPPET AFFIXMENT,” and “PRESS TO SPECIFICATION SOLENOID VALVE ASSEMBLY,” respectively, each filed on the same day as the instant application, and the contents of which are incorporated herein by reference.

### BACKGROUND OF THE INVENTION

### Field of the Invention

The present disclosure relates generally to solenoid valves and more specifically relates to miniature solenoid valves.

### Description of the Related Art

Current solenoid valves typically use one of two types of interfaces between solenoid coil and plunger. First, a stem type armature assembly typically includes a plunger mounted within a non-ferromagnetic guide tube. In such a design, the solenoid coil is supported by a separate bobbin which is removably mounted to the guide tube. Such a design can be disadvantageous in terms of part size and complexity.

Second, an integrated system typically includes a plunger that is allowed to linearly slide within a molded plastic bobbin supporting the coil. In such a design, the interior bore of the bobbin needs a draft angle to allow for moldability. Such a draft angle within the internal bore can cause issues with the alignment of the plunger within the central axis of the bore. Misalignment in the form of plunger tilt with respect to the axis of the bore can cause the elastomer seal or seals, that are part of or mounted to the plunger, to become misaligned with respect to the valve seats. This tilt, or angular misalignment, can cause increased deformation of the elastomer into the valve seat in order to compensate and allow the valve to seal. Such increased deformation can have various negative impacts on valve function, such as increased current to actuate, increased current to hold, reduced pressure rating, increased leak rate, reduced valve efficiency, reduced valve life, reduced maximum possible flow rating, compression set of the elastomer, or any combination thereof.

### SUMMARY OF THE INVENTION

Applicants have created new and useful devices, systems and methods for solenoid valves. In at least one embodiment, a valve according to the disclosure can have a valve body with a port section and a coil support section extending along a longitudinal axis, a bore extending at least partially through the coil support section, a plunger slidingly received in the bore, at least one cylindrical bore bearing surface in the bore configured to align the plunger within the bore, or any combination thereof. In at least one embodiment, the at least one cylindrical bore bearing surface can include a first cylindrical bore bearing surface, such as at least partially in the coil support section of the body, and a second cylindrical bore bearing surface. In at least one embodiment, the bore can include a conical section between the first cylindrical bore bearing surface and the second cylindrical bore bearing surface. In at least one embodiment, the conical section of the bore can be angled with respect to the first cylindrical bore bearing surface and/or the second cylindrical bore bearing surface. In at least one embodiment, the first cylindrical bore bearing surface can have a larger diameter than the second cylindrical bore bearing surface. In at least one embodiment, one or more bushings can provide the first cylindrical bore bearing surface and/or the second cylindrical bore bearing surface, with the body being over-molded onto the bushing(s). In at least one embodiment, at least the coil support section of the body can be injection molded polymer.

In at least one embodiment, the second cylindrical bore bearing surface can be at least partially located in the port section of the body. In at least one embodiment, a poppet can be mounted on the plunger and slidingly received in the port section of the body. In at least one embodiment, the poppet can include a cylindrical poppet bearing surface configured to cooperate with the second cylindrical bore bearing surface to align the plunger within the bore.

In at least one embodiment, the plunger can include a first cylindrical plunger bearing surface configured to cooperate with one of the cylindrical bore bearing surfaces to align the plunger within the bore. In at least one embodiment, the plunger can include a second cylindrical plunger bearing surface configured to cooperate with one of the cylindrical bore bearing surfaces to align the plunger within the bore. In at least one embodiment, the second cylindrical plunger bearing surface can be longitudinally spaced from the first cylindrical plunger bearing surface. In at least one embodiment, the first cylindrical plunger bearing surface can have a larger diameter than the second cylindrical plunger bearing surface.

In at least one embodiment, a valve according to the disclosure can have a valve body having a port section and a coil support section extending along a longitudinal axis, with a bore extending at least partially through the coil support section, a plunger slidingly received in the bore, a first cylindrical bore bearing surface at least partially in the coil support section of the body and a second cylindrical bore bearing surface longitudinally spaced from the first cylindrical bore bearing surface, the first and second cylindrical bore bearing surfaces configured to align the plunger within the bore, or any combination thereof.

In at least one embodiment, the bore can include a conical section between the first cylindrical bore bearing surface and the second cylindrical bore bearing surface. In at least one embodiment, the conical section of the bore can be angled with respect to the first cylindrical bore bearing surface and/or the second cylindrical bore bearing surface. In at least one embodiment, the first cylindrical bore bearing surface can have a larger diameter than the second cylindrical bore bearing surface. In at least one embodiment, one or more bushings can provide the first cylindrical bore bearing surface and/or the second cylindrical bore bearing surface, with the body being over-molded onto the bushing(s). In at least one embodiment, at least the coil support section of the body can be injection molded polymer.

In at least one embodiment, the second cylindrical bore bearing surface can be at least partially located in the port section of the body. In at least one embodiment, a poppet can be mounted on the plunger and slidingly received in the port section of the body. In at least one embodiment, the poppet can include a cylindrical poppet bearing surface configured to cooperate with the second cylindrical bore bearing surface to align the plunger within the bore.

In at least one embodiment, the plunger can include a first cylindrical plunger bearing surface configured to cooperate with one of the cylindrical bore bearing surfaces to align the plunger within the bore. In at least one embodiment, the plunger can include a second cylindrical plunger bearing surface configured to cooperate with one of the cylindrical bore bearing surfaces to align the plunger within the bore. In at least one embodiment, the second cylindrical plunger bearing surface can be longitudinally spaced from the first cylindrical plunger bearing surface. In at least one embodiment, the first cylindrical plunger bearing surface can have a larger diameter than the second cylindrical plunger bearing surface.

### BRIEF DESCRIPTION OF DRAWINGS

FIG. 1 is a cross sectional view of one of many embodiments of a solenoid valve according to the disclosure.

FIG. 2 is a cross sectional view of one of many embodiments of portions of a solenoid valve according to the disclosure.

FIG. 3 is a cross sectional view of one of many embodiments of a valve body according to the disclosure.

FIG. 4 is a cross sectional view of another one of many embodiments of a valve body according to the disclosure.

FIG. 5 is a simplified diagram of a portion of one of many embodiments of a valve body according to the disclosure, exaggerated to better show a conical section thereof.

FIG. 6 is an elevation view of one of many embodiments of a plunger according to the disclosure.

FIG. 7 is a cross sectional perspective view of one of many embodiments of a poppet according to the disclosure.

### DETAILED DESCRIPTION OF THE INVENTION

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Any process flowcharts discussed herein illustrate the operation of possible implementations of systems, methods, and computer program products according to various embodiments of the present disclosure. In this regard, each block in a flowchart may represent a module, segment, or portion of code, which can comprise one or more executable instructions for implementing the specified logical function(s). It should also be noted that, in some implementations, the function(s) noted in the block(s) might occur out of the order depicted in the figures. For example, blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Applicants have created new and useful devices, systems and methods for solenoid valves. By including undrafted, or cylindrical, bearing surfaces in the bore of the valve body, the plunger can be aligned within the bore, thereby reducing both angular and parallel offset misalignment of the plunger. This can maintain alignment of the elastomer seal or seals, that are part of or mounted to the plunger, with respect to the valve seats, thereby increasing valve efficiency and lifespan, such as by reducing pull-in current, reducing holding current, increasing pressure rating, reducing compression set, reducing leakage rate, increasing valve performance and/or flow rate, or any combination thereof.

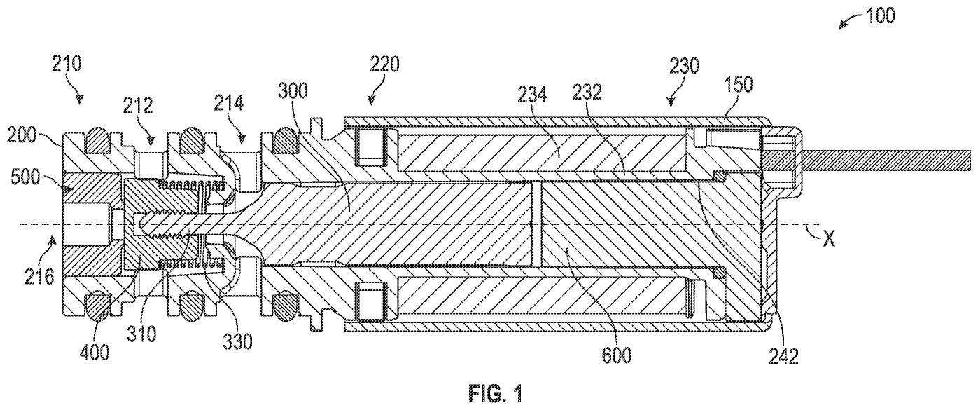

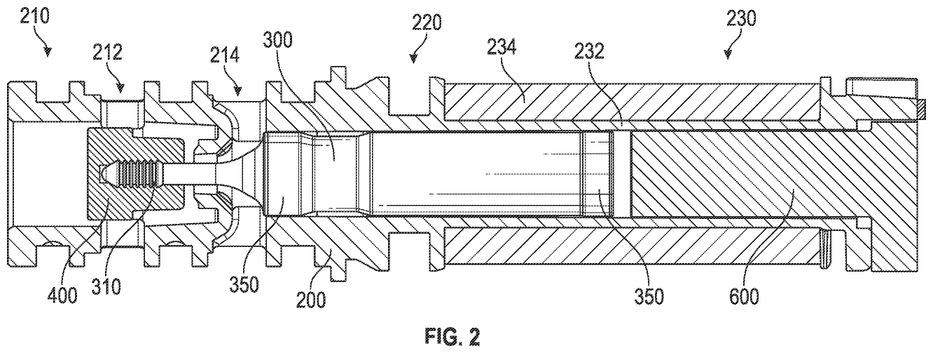

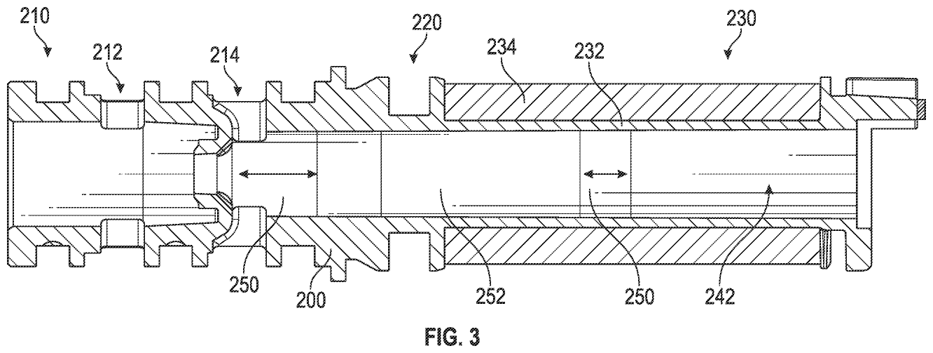

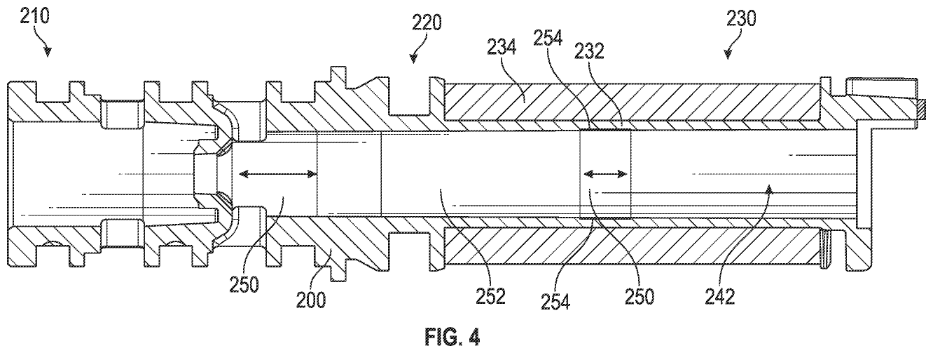

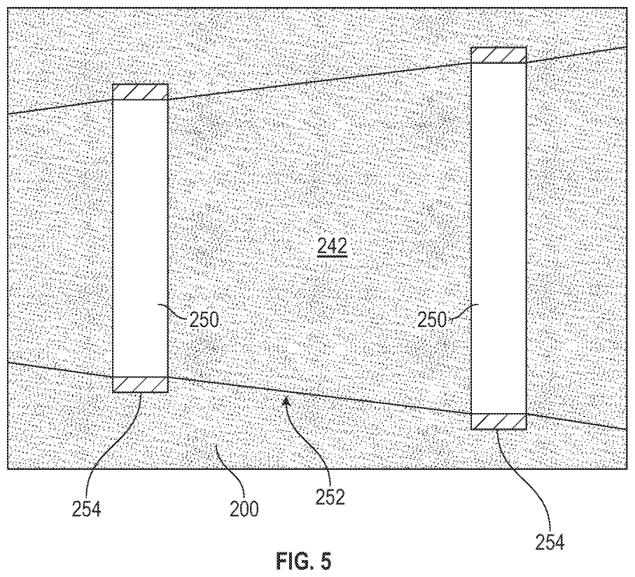

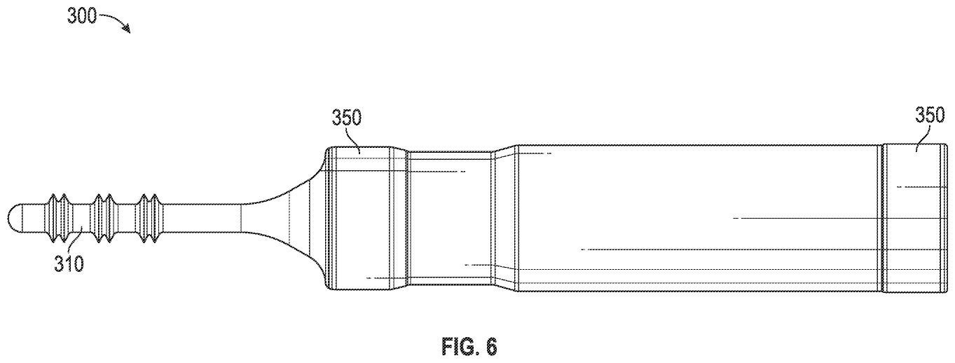

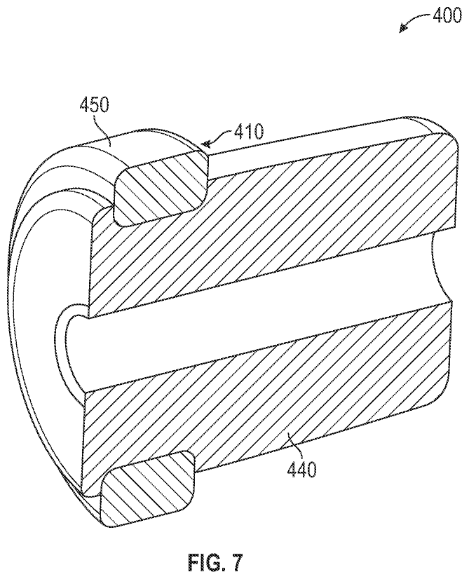

FIG. 1 is a cross sectional view of one of many embodiments of a solenoid valve according to the disclosure. FIG. 2 is a cross sectional view of one of many embodiments of portions of a solenoid valve according to the disclosure. FIG. 3 is a cross sectional view of one of many embodiments of a valve body according to the disclosure. FIG. 4 is a cross sectional view of another one of many embodiments of a valve body according to the disclosure. FIG. 5 is a simplified diagram of a portion of one of many embodiments of a valve body according to the disclosure, exaggerated to better show a conical section thereof. FIG. 6 is an elevation view of one of many embodiments of a plunger according to the disclosure. FIG. 7 is a cross sectional perspective view of one of many embodiments of a poppet according to the disclosure. FIGS. 1-7 are described in conjunction with one another.

In at least one embodiment, a valve 100 according to the disclosure, such as a miniature solenoid valve, can include one or more valve bodies 200, one or more plungers 300 disposed at least partially within the valve body 200, one or more poppets 400 coupled to the plunger 300, one or more end caps 500 coupled at least partially within the valve body 200, one or more stops 600 coupled at least partially within the valve body 200, or any combination thereof. In at least one embodiment, the poppet 400 can be press-fit onto the plunger 300. In at least one embodiment, the cap 500 and/or the stop 600 can limit movement of the plunger 300 and/or poppet 400. In at least one embodiment, the cap 500 and/or the stop 600 can be press-fit into the valve body 200.

In at least one embodiment, the valve body 200 can include one or more port sections 210, one or more flux collar support sections 220, one or more coil support sections 230, or any combination thereof, extending along one or more axes, such as a central longitudinal axis X. In at least one embodiment, the port section 210 can include one or more common ports 212, one or more normally open ports 214, and one or more normally closed ports 216, or any combination thereof. In at least one embodiment, the flux collar support section 220 can support a flux collar, such as to improve efficiency of the valve 100. In at least one embodiment, the port section 210, the flux collar support section 220, and the coil support section 230 of the valve body 200 can be a unitary or monolithic structure, such as by way of being portions of an integrally formed structure (e.g., an injection molded structure).

In at least one embodiment, the plunger 300 can extend at least partially through the flux collar support section 220 and the coil support section 230. In at least one embodiment, the plunger 300 can extend at least partially through a flux collar supported by the flux collar support section 220. In at least one embodiment, the plunger 300 can include one or more stems 310 that extend into the port section 210. In at least one embodiment, the plunger 300 can include one or more poppets 400 mounted to the stem 310. In at least one embodiment, one or more biasing members 330, such as a spring, can bias the plunger 300 and/or poppet 400 towards or away from one or more caps 500.

In at least one embodiment, the coil support section 230 of the valve body 200 can include one or more annular walls 232 and/or one or more coils 234. In at least one embodiment, the wall 232 can support coil 234, which can selectively actuate, or move, the plunger 300 against the force of the spring 330, to thereby switch the valve 100 from a normally open position to a normally closed position. In at least one embodiment, the annular walls 232 can define or encompass a bore 242 extending through the valve body 200 in which the plunger 300 can reciprocate. In at least one embodiment, the coil support section 230 can include one or more stops 600, such as a core and/or related structure, to limit the movement of the plunger 300 in one or more directions within the bore 242. In at least one embodiment, the stop 600 can be a single, unitary structure. In at least one embodiment, the stop 600 can be or include a plurality of structures.

In at least one embodiment, a valve 100 according to the disclosure can include one or more a poppets 400 press-fit onto the plunger 300 and configured to selectively open and close at least one flow path through the port section 210 of the valve body 200. In at least one embodiment, the plunger 300 can include a stem 310 extending into the port section 210 of the valve body 200. In at least one embodiment, the poppet 400 can include one or more shoulders 410 against which the spring 330 can rest and thereby bias the poppet 400 towards a normal operating position, opening a normally open flow path and/or closing a normally closed flow path through the valve body 210. In at least one embodiment, the coil 234 can overcome the spring 330 to move the plunger 300 and poppet 400 to close a normally open flow path and/or open a normally closed flow path through the valve body 210.

In at least one embodiment, the bore 242 can extend at least partially through the coil support section 230 and the plunger 300 can be longitudinally and/or slidingly or slideably disposed in or otherwise coupled to the bore 242. In at least one embodiment, the bore 242 can include one or more cylindrical bore bearing surface 250 can help to align the plunger 300 within the bore 242. In at least one embodiment, the bore 242 can include a first cylindrical bore bearing surface 250, such as at least partially in the coil support section 230 of the body 200, and a second cylindrical bore bearing surface 250. In at least one embodiment, the first cylindrical bore bearing surface 250 can have a larger diameter than the second cylindrical bore bearing surface 250. In at least one embodiment, the first cylindrical bore bearing surface 250 can be parallel with the second cylindrical bore bearing surface 250. In at least one embodiment, the first cylindrical bore bearing surface 250 can appear concentric with respect to the second cylindrical bore bearing surface 250, when viewed along the longitudinal axis of the valve body 200.

In at least one embodiment, the bore 242 can include a conical section 252 between the first cylindrical bore bearing surface 250 and the second cylindrical bore bearing surface 250. In at least one embodiment, the conical section 252 of the bore 242 can be angled with respect to the first cylindrical bore bearing surface 250 and/or the second cylindrical bore bearing surface 250. In at least one embodiment, one or more bushings 254 can provide the first and/or second cylindrical bore bearing surface 250, with the valve body 200, or a portion thereof (such as the coil support section 230), being over-molded onto the bushing(s) 254. In at least one embodiment, at least the coil support section 230 of the valve body 200 can be injection molded polymer.

In at least one embodiment, the plunger 300 can include a first cylindrical plunger bearing surface 350 configured to cooperate with one of the cylindrical bore bearing surfaces 250 to align the plunger 300 within the bore 242. In at least one embodiment, the plunger 300 can include a second cylindrical plunger bearing surface 350 configured to cooperate with one of the cylindrical bore bearing surfaces 250 to align the plunger 300 within the bore 242. In at least one embodiment, the second cylindrical plunger bearing surface 350 can be longitudinally spaced from the first cylindrical plunger bearing surface 350. In at least one embodiment, the first cylindrical plunger bearing surface 350 can have a larger diameter than the second cylindrical plunger bearing surface 350.

In at least one embodiment, the poppet 400 can be press-fit onto the stem 310 of the plunger 300. In at least one embodiment, the poppet 400 can be unitary or made of multiple portions. In at least one embodiment, the poppet 400 can include a more rigid portion configured to engage the stem 310. In at least one embodiment, the poppet 400 can include a more a resilient portion configured to selectively engage one or more valve seats to selectively open and close the flow path through the port section 210 of the valve body 200. In at least one embodiment, with the rigid portion being harder, or more rigid, than the resilient portion 440, the rigid portion can better hold the poppet 400 in place along the stem 310 of the plunger 300. In at least one embodiment, with the resilient portion 440 being more resilient, softer, and/or more elastomeric than the rigid portion, the resilient portion 440 can better seal with the valve seats. In at least one embodiment, the resilient portion 440 can be pulled at least partially into, thru, or onto the rigid portion.

In at least one embodiment, the poppet 400 can include one or more bands 450 around a perimeter of the poppet 400 to secure the poppet 400 to the stem 310. In at least one embodiment, the poppet 400 can be pulled at least partially into, or thru, the band 450. In at least one embodiment, one or more of the bands 450 can be metal and/or crimped onto the poppet 400, thereby securing the poppet 400 to the stem 310. In at least one embodiment, the band 450 can be a more rigid polymer than the poppet 400, or the resilient portion 440 thereof, thereby supporting and/or securing the poppet 400 to the stem 310.

In at least one embodiment, the second cylindrical bore bearing surface 250 can be at least partially located in the port section 210 of the valve body 200. In at least one embodiment, the poppet 400 can be mounted on the plunger 300 and slideably disposed in the port section 210 of the valve body 200. In at least one embodiment, the poppet can include a cylindrical poppet bearing surface, which can be provided by one or more of the bands 450 and/or the resilient portion of the poppet 400, to cooperate with the second cylindrical bore bearing surface 250 to align the plunger 300 within the bore 242.

In at least one embodiment, the poppet 400 can selectively engage one or more valve seats to selectively open and close one or more flow paths through the port section 210 of the valve body 200. In at least one embodiment, one or more valve seats can be integral with the valve body 200 and/or can be part of a normally open or normally closed flow path. In at least one embodiment, one or more valve seats can be integral with a cap 500 press-fit into one end of the valve body 200.

In at least one embodiment, a valve 100 according to the disclosure, such as a miniature solenoid valve, can include one or more valve bodies 200 having a port section 210 and a coil support section 230 extending along a longitudinal axis, one or more plungers 300 within the valve body 200 and extending at least partially through the coil support section 230, a poppet 400 including a resilient portion 440 configured to selectively engage a rigid valve seat to open and close at least one flow path through the port section 210 of the valve body 200, or any combination thereof. In at least one embodiment, the plunger 300 can include one or more stems 310 extending into the port section 210 of the valve body 200. In at least one embodiment, the stem 310 can engage an interior of the poppet 400 to hold the poppet 400 in place on the stem 310. In at least one embodiment, one or more of the valve seats can be integral with the valve body 200. In at least one embodiment, one or more of the valve seats can be integral with a cap 500 press-fit into one end of the valve body 200.

In at least one embodiment, a bore can extend at least partially through the coil support section 230 and the plunger 300 can be slideably coupled the bore 242. In at least one embodiment, a first cylindrical bore bearing surface 250 can be located at least partially in the coil support section 230 of the valve body 200 and/or a second cylindrical bore bearing surface 250 can be longitudinally spaced from the first cylindrical bore bearing surface 250. In at least one embodiment, the first and second cylindrical bore bearing surfaces 250 can align the plunger 300 within the bore 242.

In at least one embodiment, the bore 242 can include a conical section 252 between the first cylindrical bore bearing surface 250 and the second cylindrical bore bearing surface 250. In at least one embodiment, the conical section 252 of the bore 242 can be angled with respect to the first cylindrical bore bearing surface 250 and/or the second cylindrical bore bearing surface 250. In at least one embodiment, the first cylindrical bore bearing surface 250 can have a larger diameter than the second cylindrical bore bearing surface 250. In at least one embodiment, one or more bushings 254 can provide the first cylindrical bore bearing surface 250 and/or the second cylindrical bore bearing surface 250, with the valve body 20, or a portion thereof, being over-molded onto the bushing(s) 254. For example, at least the coil support section 230 of the valve body 200 can be injection molded polymer and/or be over-molded onto the bushing(s) 254.

In at least one embodiment, the second cylindrical bore bearing surface 250 can be at least partially located in the port section 210 of the valve body 200. In at least one embodiment, a poppet 400 can be mounted on the plunger 300 and slideably disposed in the port section 210 of the valve body 200. In at least one embodiment, the poppet 400 can include a cylindrical poppet bearing surface 450 configured to cooperate with the second cylindrical bore bearing surface 250 to align the plunger 300 within the bore 242.

In at least one embodiment, the plunger 300 can include a first cylindrical plunger bearing surface 350 configured to cooperate with one of the cylindrical bore bearing surfaces 250 to align the plunger 300 within the bore 242. In at least one embodiment, the plunger 300 can include a second cylindrical plunger bearing surface 350 configured to cooperate with one of the cylindrical bore bearing surfaces 250 to align the plunger 300 within the bore 242. In at least one embodiment, the second cylindrical plunger bearing surface 350 can be longitudinally spaced from the first cylindrical plunger bearing surface 350. In at least one embodiment, the first cylindrical plunger bearing surface 350 can have a larger diameter than the second cylindrical plunger bearing surface 350.

In at least one embodiment, a valve according to the disclosure can have a valve body with a port section and a coil support section extending along a longitudinal axis, with a bore extending at least partially through the coil support section, a plunger longitudinally and/or slidingly received in the bore, at least one cylindrical bore bearing surface in the bore configured to align the plunger within the bore, or any combination thereof. In at least one embodiment, the at least one cylindrical bore bearing surface can include a first cylindrical bore bearing surface, such as at least partially in the coil support section of the body, and a second cylindrical bore bearing surface. In at least one embodiment, the bore can include a conical section between the first cylindrical bore bearing surface and the second cylindrical bore bearing surface. In at least one embodiment, the conical section of the bore can be angled with respect to the first cylindrical bore bearing surface and/or the second cylindrical bore bearing surface. In at least one embodiment, the first cylindrical bore bearing surface can have a larger diameter than the second cylindrical bore bearing surface. In at least one embodiment, one or more bushings can provide the first cylindrical bore bearing surface and/or the second cylindrical bore bearing surface, with the body being over-molded onto the bushing(s). In at least one embodiment, at least the coil support section of the body can be injection molded polymer.

In at least one embodiment, the second cylindrical bore bearing surface can be at least partially located in the port section of the body. In at least one embodiment, a poppet can be mounted on the plunger and slidingly received in the port section of the body. In at least one embodiment, the poppet can include a cylindrical poppet bearing surface configured to cooperate with the second cylindrical bore bearing surface to align the plunger within the bore.

In at least one embodiment, the plunger can include a first cylindrical plunger bearing surface configured to cooperate with one of the cylindrical bore bearing surfaces to align the plunger within the bore. In at least one embodiment, the plunger can include a second cylindrical plunger bearing surface configured to cooperate with one of the cylindrical bore bearing surfaces to align the plunger within the bore. In at least one embodiment, the second cylindrical plunger bearing surface can be longitudinally spaced from the first cylindrical plunger bearing surface. In at least one embodiment, the first cylindrical plunger bearing surface can have a larger diameter than the second cylindrical plunger bearing surface.

In at least one embodiment, a valve according to the disclosure can have a valve body having a port section and a coil support section extending along a longitudinal axis, with a bore extending at least partially through the coil support section, a plunger longitudinally and/or slidingly received in the bore, a first cylindrical bore bearing surface at least partially in the coil support section of the body and a second cylindrical bore bearing surface longitudinally spaced from the first cylindrical bore bearing surface, the first and second cylindrical bore bearing surfaces configured to align the plunger within the bore, or any combination thereof.

In at least one embodiment, the bore can include a conical section between the first cylindrical bore bearing surface and the second cylindrical bore bearing surface. In at least one embodiment, the conical section of the bore can be angled with respect to the first cylindrical bore bearing surface and/or the second cylindrical bore bearing surface. In at least one embodiment, the first cylindrical bore bearing surface can have a larger diameter than the second cylindrical bore bearing surface. In at least one embodiment, one or more bushings can provide the first cylindrical bore bearing surface and/or the second cylindrical bore bearing surface, with the body being over-molded onto the bushing(s). In at least one embodiment, at least the coil support section of the body can be injection molded polymer.

In at least one embodiment, the second cylindrical bore bearing surface can be at least partially located in the port section of the body. In at least one embodiment, a poppet can be mounted on the plunger and slidingly received in the port section of the body. In at least one embodiment, the poppet can include a cylindrical poppet bearing surface configured to cooperate with the second cylindrical bore bearing surface to align the plunger within the bore.

In at least one embodiment, the plunger can include a first cylindrical plunger bearing surface configured to cooperate with one of the cylindrical bore bearing surfaces to align the plunger within the bore. In at least one embodiment, the plunger can include a second cylindrical plunger bearing surface configured to cooperate with one of the cylindrical bore bearing surfaces to align the plunger within the bore. In at least one embodiment, the second cylindrical plunger bearing surface can be longitudinally spaced from the first cylindrical plunger bearing surface. In at least one embodiment, the first cylindrical plunger bearing surface can have a larger diameter than the second cylindrical plunger bearing surface.

Other and further embodiments utilizing one or more aspects of the disclosure can be devised without departing from the spirit of Applicants' disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicants, but rather, in conformity with the patent laws, Applicants intend to fully protect all such modifications and improvements that come within the scope or range of equivalents of the following claims.

1. A valve comprising:
a valve body having a port section and a coil support section extending along a longitudinal axis, the body including a bore extending at least partially through the coil support section;
a plunger slideably coupled in the bore; and
at least one cylindrical bore bearing surface in the bore configured to align the plunger within the bore.

2. The valve of claim 1, wherein the at least one cylindrical bore bearing surface comprises a first cylindrical bore bearing surface at least partially in the coil support section of the body and a second cylindrical bore bearing surface.

3. The valve of claim 2, wherein the second cylindrical bore bearing surface is at least partially in the port section of the body.

4. The valve of claim 3, further including a poppet mounted on the plunger and slideably received in the port section of the body; wherein the poppet includes a cylindrical poppet bearing surface configured to cooperate with the second cylindrical bore bearing surface to align the plunger within the bore.

5. The valve of claim 2, wherein the bore further includes a conical section between the first cylindrical bore bearing surface and the second cylindrical bore bearing surface.

6. The valve of claim 5, wherein the conical section of the bore is angled with respect to the first cylindrical bore bearing surface and the second cylindrical bore bearing surface.

7. The valve of claim 2, wherein the first cylindrical bore bearing surface has a larger diameter than the second cylindrical bore bearing surface.

8. The valve of claim 1, wherein the plunger includes a first cylindrical plunger bearing surface configured to cooperate with the at least one cylindrical bore bearing surface to align the plunger within the bore.

9. The valve of claim 8, wherein the plunger includes a second cylindrical plunger bearing surface longitudinally spaced from the first cylindrical plunger bearing surface.

10. The valve of claim 9, wherein the first cylindrical plunger bearing surface has a larger diameter than the second cylindrical plunger bearing surface.

11. The valve of claim 1, wherein at least the coil support section of the body comprises injection molded polymer; wherein the at least one cylindrical bore bearing surface comprises a first cylindrical bore bearing surface at least partially in the coil support section of the body and a second cylindrical bore bearing surface; wherein the first cylindrical bore bearing surface has a larger diameter than the second cylindrical bore bearing surface; and wherein the bore further includes a conical section between the first cylindrical bore bearing surface and the second cylindrical bore bearing surface.

12. The valve of claim 11, wherein the first and second cylindrical bore bearing surfaces comprise bushings and wherein the body is over-molded onto the bushings.

13. A valve comprising:
a valve body having a port section and a coil support section extending along a longitudinal axis, the body including a bore extending at least partially through the coil support section;
a plunger slideably disposed in the bore;
a first cylindrical bore bearing surface at least partially in the coil support section of the body; and
a second cylindrical bore bearing surface longitudinally spaced from the first cylindrical bore bearing surface;
wherein the first and second cylindrical bore bearing surfaces are configured to align the plunger within the bore.

14. The valve of claim 13, wherein the second cylindrical bore bearing surface is at least partially in the port section of the body.

15. The valve of claim 14, further including a poppet mounted on the plunger and slideably received in the port section of the body; wherein the poppet includes a cylindrical poppet bearing surface configured to cooperate with the second cylindrical bore bearing surface to align the plunger within the bore.

16. The valve of claim 13, wherein the bore further includes a conical section between the first cylindrical bore bearing surface and the second cylindrical bore bearing surface; and wherein the conical section of the bore is angled with respect to the first cylindrical bore bearing surface and the second cylindrical bore bearing surface.

17. The valve of claim 13, wherein the first cylindrical bore bearing surface has a larger diameter than the second cylindrical bore bearing surface.

18. The valve of claim 13, wherein the plunger includes a first cylindrical plunger bearing surface configured to cooperate with the first cylindrical bore bearing surface and a second cylindrical plunger bearing surface configured to cooperate with the second cylindrical bore bearing surface.

19. The valve of claim 13, wherein at least the coil support section of the body comprises injection molded polymer; wherein the first cylindrical bore bearing surface has a larger diameter than the second cylindrical bore bearing surface; and wherein the bore further includes a conical section between the first cylindrical bore bearing surface and the second cylindrical bore bearing surface.

20. The valve of claim 11, wherein the first and second cylindrical bore bearing surfaces comprise bushings and wherein the body is over-molded onto the bushings.
